(19) United States
(12) Patent Application Publication
(10) Pub. No.: US 2026/0052118 A1
(43) Pub. Date: Feb. 19, 2026

(54) METHOD, APPARATUS, DEVICE, AND STORAGE MEDIUM FOR MESSAGE INTERACTION

(71) Applicants: Beijing Zitiao Network Technology Co., Ltd., Beijing (CN); LEMON INC., Grand Cayman (KY)

(72) Inventors: Jiahui Yang, Beijing (CN); Jiayi Xu, Beijing (CN); Wei Xu, Los Angeles, CA (US)

(21) Appl. No.: 19/302,768

(22) Filed: Aug. 18, 2025

(30) Foreign Application Priority Data
Aug. 19, 2024 (WO) PCT/CN2024/113216

(51) Int. Cl. H04L 51/04; H04W 4/14

(52) U.S. Cl. CPC H04L 51/04; H04W 4/14

(57) ABSTRACT

Embodiments of the disclosure relate to a method, an apparatus, a device, and a storage medium for message interaction. The method provided herein includes: presenting an interaction component, the interaction component presenting a plurality of interaction items; receiving a selection of a target interaction item from the plurality of interaction items by a current user; and triggering to send an interaction message to a target user corresponding to the target interaction item based on a target transmission mode. The target transmission mode is determined from a plurality of predetermined transmission modes based on source information of the target user. The interaction message indicates an interaction between the current user and the interaction component. In this way, the embodiments of the disclosure can improve message interaction efficiency.

### CROSS-REFERENCE

The present application claims priority to International Patent Application No. PCT/CN2024/113216, filed on Aug. 19, 2024, and entitled “METHOD, APPARATUS, DEVICE, AND STORAGE MEDIUM FOR MESSAGE INTERACTION”, the entirety of which is incorporated herein by reference.

### FIELD

Example embodiments of the disclosure generally relate to the field of computers, and more particularly, to a method, an apparatus, a device, and a computer-readable storage medium for message interaction.

### BACKGROUND

In recent years, with development of the Internet, more and more people conduct network activities in a plurality of network platforms. For example, people perform message interaction on a network platform. However, the interaction manners provided by an existing network platform cannot meet the need of a user to interact with users from different sources.

### SUMMARY

In a first aspect of the present disclosure, a method for message interaction is provided, including: presenting an interaction component, the interaction component presenting a plurality of interaction items; receiving a selection of a target interaction item from the plurality of interaction items by a current user; and triggering to send an interaction message to a target user corresponding to the target interaction item based on a target transmission mode, wherein the target transmission mode is determined from a plurality of predetermined transmission modes based on source information of the target user, and the interaction message indicates an interaction between the current user and the interaction component.

In a second aspect of the present disclosure, an apparatus for message interaction is provided. The apparatus comprises: a presenting module configured to present an interaction component, the interaction component presenting a plurality of interaction items; a receiving module configured to receive a selection of a target interaction item from the plurality of interaction items by a current user; and a processing module configured to trigger to send an interaction message to a target user corresponding to the target interaction item based on a target transmission mode, wherein the target transmission mode is determined from a plurality of predetermined transmission modes based on source information of the target user, and the interaction message indicates an interaction between the current user and the interaction component.

In a third aspect of the present disclosure, there is provided an electronic device. The device comprises at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer readable storage medium is provided. The computer readable storage medium stores a computer program thereon, and the computer program is executable by a processor to implement the method in the first aspect.

It should be appreciated that what is described in this Summary is not intended to limit critical features or essential features of embodiments of the present disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar drawing reference numerals denote the same or similar elements, wherein:

FIG. 1 illustrates a schematic diagram of an example environment in which some embodiments of the present disclosure can be implemented;

FIGS. 2A-2D illustrate example interfaces according to some embodiments of the present disclosure;

FIGS. 3A-3E illustrate example interfaces according to yet other embodiments of the present disclosure;

FIG. 4 illustrates a flowchart of an example process for message interaction according to some embodiments of the present disclosure;

FIG. 5 illustrates a schematic structural block diagram of an example apparatus for message interaction according to some embodiments of the present disclosure; and

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data, acquisition and/or use of data, etc. by a user, all of which follows respective legal regulations and related regulations. In embodiments of the present disclosure, all data collection, acquisition, handling, processing, forwarding, use, and the like, are made with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user is obtained. The specific informing and/or authorization manner may vary according to actual situations and application scenarios, and the scope of the present disclosure is not limited in this aspect.

In the solutions of the present description and embodiments, if the processing of personal information is involved, the processing will be carried out on the premise that it is legal (e.g., obtaining consent of the subject of the personal information or it is necessary for the fulfillment of a contract, etc.), and the processing will be carried out only within the scope of the stipulations or agreements. The refusal of the user to process personal information other than that which is necessary for the basic functions will not affect the use of the basic functions.

As mentioned briefly above, with the development of the Internet, more and more people conduct network activities on multiple network platforms. For example, people perform message interaction on a network platform. However, the interaction manners provided by an existing network platform cannot meet the need of a user to interact with users from different sources based on different transmission modes.

The embodiments of the present disclosure provide a solution for message interaction. According to the solution, an interaction component may be presented, and the interaction component presents a plurality of interaction items. A selection of a target interaction item from a plurality of interaction items by a current user is received. An interaction message is triggered to be sent to a target user corresponding to the target interaction item based on a target transmission mode. The target transmission mode is determined from a plurality of predetermined transmission modes based on source information of the target user. The interaction message indicates an interaction between the current user and the interaction component.

In this way, the embodiments of the present disclosure can receive a selection of a target interaction item by a current user, and can determine, based on source information of a target user corresponding to the target interaction item, a target transmission mode from a plurality of predetermined transmission modes. Further, the embodiments of the present disclosure can send an interaction message to a target user based on a target transmission mode. In this way, the embodiments of the present disclosure can provide a user with a plurality of transmission modes, and send an interaction message based on a transmission mode determined by an interaction operation of the user. Therefore, the embodiments of the present disclosure can meet the need of a user to interact with users from different sources.

Various example implementations of the solution are described in further detail below with reference to the accompanying drawings.

### Example Environment

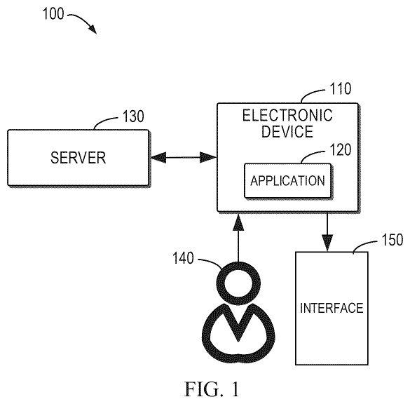

FIG. 1 illustrates a schematic diagram of an example environment 100 in which embodiments of the present disclosure can be implemented. As shown in FIG. 1, the example environment 100 may include an electronic device 110.

In this example environment 100, an application 120 that supports interface interaction may run on the electronic device 110. The application 120 may be any suitable type of application for interface interaction, examples of which can include, but are not limited to, video applications, social applications, or other suitable applications. The user 140 may interact with application 120 via electronic device 110 and/or an attached device thereof.

In the environment 100 of FIG. 1, if the application 120 is active, the electronic device 110 may present an interface 150 for support interface interaction through the application 120.

In some embodiments, the electronic device 110 communicates with the server 130 to enable provision of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System (PCS) device, a personal navigation device, a personal digital assistant (PDA), an audio/video player, a digital camera/camcorder, a positioning device, a television receiver, a radio broadcast receiver, an electronic book device, a game device, or any combination of the foregoing, including accessories and peripherals for these devices, or any combination thereof. In some embodiments, the electronic device 110 can also support any type of interface for a user (such as “wearable” circuitry, etc.).

The server 130 may be an independent physical server, or a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for the application 120 supporting the virtual scene in the electronic device 110.

A communication connection may be established between the server 130 and the electronic device 110. The communication connection may be established in a wired manner or a wireless manner. The communication connection may include, but are not limited to, Bluetooth connections, mobile network connections, Universal Serial Bus (USB) connections, Wireless Fidelity (WIFI) connections, and the like, and the embodiments of the present disclosure are not limited in this regard. In an embodiment of the present disclosure, the server 130 and the electronic device 110 may achieve signaling interaction through a communication connection therebetween.

It should be understood that the structure and function of the various elements in environment 100 are described for illustrative purposes only, and are not intended to imply any limitation on the scope of the disclosure.

Some example embodiments of the present disclosure will be described below with continued reference to the accompanying drawings.

### Interaction Message Generation Based on Interaction Components

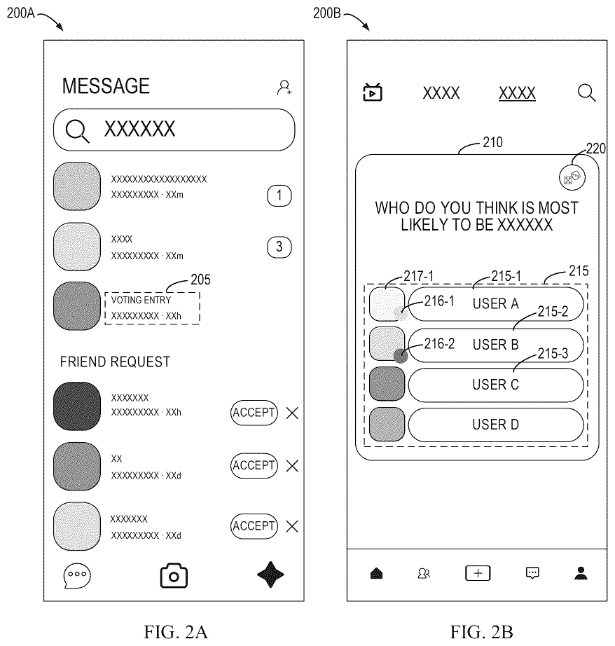

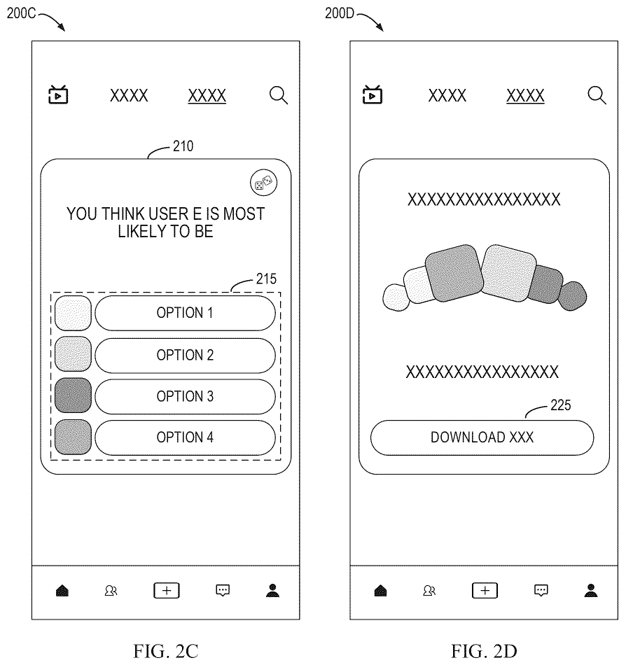

FIGS. 2A-2D illustrate example interfaces 200A-200D according to some embodiments of the disclosure. The interfaces 200A-200D may be provided, for example, by the electronic device 110 shown in FIG. 1.

In some embodiments, as shown in FIG. 2A, the electronic device 110 may present a message interface 200A. As an example, the electronic device 110 may present message content (e.g., messages received from other users or friend requests from other users, etc.) received by the current user in message interface 200A.

In some embodiments, with continued reference to FIG. 2A, the electronic device 110 may present the interaction entry 205 in the message interface 200A. By way of example, the electronic device 110 may provide an interaction entry 205 (e.g., also referred to as a voting entry 205) in a message interface. Further, the electronic device 110 may present an interaction component associated with the interaction entry 205 in response to a trigger (e.g., a clicking operation) to the interaction entry 205. In some embodiments, the electronic device 110 may also present an interaction entry 205, for example, in a viewing interface.

In some embodiments, as shown in FIG. 2B, the electronic device 110 may present a viewing interface 200B. The electronic device 110 may present an interaction component 210 in the viewing interface 200B.

By way of example, the electronic device 110 may present the interaction component 210 in the viewing interface 200B in response to a trigger to the interaction entry 205.

In some embodiments, with continued reference to FIG. 2B, the electronic device 110 may present an interaction component 210 in a viewing interface 200B of the information stream. In some instances, the information stream, also referred to as Feed flow, may be associated with a plurality of works, and support a predetermined operation (e.g., swiping up and down) by a current user in the viewing interface 200B to switch to the playing of other works in the information stream. By way of example, the electronic device 110 may present interaction component 210 in the viewing interface 200B in response to receiving a predetermined operation (e.g., a swiping up or down operation or clicking operation, etc.) of the current user in the viewing interface 200B.

In some embodiments, the information streams may be associated with a plurality of work types. By way of example, the work type may include, but is not limited to, a video work, an image-text work, a music work, etc.

In some embodiments, the electronic device 110 may present the interaction component 210 in the viewing interface 200B of the first application. At this point, the interaction component 210 may be associated with the first application.

In some embodiments, with continued reference to FIG. 2B, the electronic device 110 presents a plurality of interaction items 215 in the interaction component 210, for example, interaction item 215-1, interaction item 215-2 (individually or collectively referred to as interaction item 215).

In some embodiments, with continued reference to FIG. 2B, the electronic device 110 may further present the description content in the interaction component 210. As an example, the description content may be a voting question (e.g., who do you think is most likely to be XXXX?) In some embodiments, a plurality of interaction items 215 may correspond to a plurality of candidate users, for example, user A, user B, user C, and user D.

In some embodiments, with continued reference to FIG. 2B, the electronic device 110 may receive a selection of a target interaction item from the plurality of interaction items 215 by the current user to determine a target user corresponding to the target interaction item. As an example, in response to receiving a clicking operation performed by the current user on a target interaction item (e.g., the interaction item 215-2) among the plurality of interaction items 215, the electronic device 110 may determine that the target user corresponding to the target interaction item (e.g., the interaction item 215-2) is the user B. In some embodiments, the current user's selection of the target interaction item (e.g., interaction item 215-2) may be used to indicate (the current user thinks) that the target user matches the described content.

In some embodiments, the plurality of candidate users is determined from a set of candidate users associated with the current user. As an example, the set of candidate users associated with the current user is provided by the current user. As an example, the set of candidate users may include a plurality of candidate users associated with the current user.

In some embodiments, with continued reference to FIG. 2B, the electronic device 110 may present in the interaction component 210 an indication element corresponding to at least one of the plurality of interaction items. The indication element may indicate a source type of at least one candidate user corresponding to the at least one interaction item. As an example, the indication element may include, for example, an application identification (or referred to as an icon) to indicate that a source type of at least one candidate user corresponding to the at least one interaction item is an application associated with the application identification.

For example, as shown in FIG. 2B, the electronic device 110 may present the indication element 216-1 associated with the interaction item 215-1 in interaction component 210. The indication element 216-1 may indicate the source type of user A corresponding to the interaction item 215-1. As an example, the user A may originate from a second application different from the first application. For example, the electronic device 110 may present the indication element 216-2 associated with the interaction item 215-2 in interaction component 210. The indication element 216-2 may indicate the source type of user B corresponding to the interaction item 215-2. As an example, the user B may be determined based on communication information associated with the current user. As an example, if the interaction item 215-3 does not have an indication element associated with it, it may represent that the user C corresponding to the interaction item 215-3 originates from the first application. As an example, the user C is associated with the same application (e.g., a first application) as the current user.

In some embodiments, with continued reference to FIG. 2B, the plurality of interaction items may include identification information for a plurality of candidate users. The identification information may include an image identification and/or a text identification. As an example, the image identification may be, for example, an avatar of the candidate user. The text identification may be, for example, a nickname or name of the candidate user, or a remark name set by the current user. As an example, as shown in FIG. 2B, the interaction item 215-1 may include an image identification 217-1 and a text identification (e.g., user A).

In some embodiments, with continued reference to FIG. 2B, based on a selection of a target interaction item from the plurality of interaction items 215 by a current user, the electronic device 110 may trigger to send an interaction message to a target user corresponding to the target interaction item based on a target transmission mode. The target transmission mode is determined from a plurality of predetermined transmission modes based on the source information of the target user. In some embodiments, the interaction message may indicate an interaction between the current user and the interaction component. For example, the interaction message may indicate a selection operation of the interaction component by the current user (e.g., the current user considers you . . . in an XX application). At this time, the interaction message may indicate a selection operation of a target interaction item by the current user, but does not include description content associated with the interaction component (e.g., a voting question). In this way, a target user receiving an interaction message needs to perform further operations (such as clicking, or further viewing, etc.) on the interaction message to obtain description content associated with an interaction component, which can increase the interactivity and interests between users.

In some embodiments, the set of candidate users associated with the current user corresponds to a plurality of predetermined transmission modes.

In some embodiments, the plurality of predetermined transmission modes may include a first transmission mode, which may be based on the first messaging service of the first application. For example, as shown in FIG. 2B, both the user C corresponding to the interaction item 215-3 and the current user may be associated with a first application. The electronic device 110 may, in response to receiving the selection of the interaction item 215-3 by the current user, send an interaction message to user C based on the first message service of the first application.

In some embodiments, the plurality of predetermined transmission modes may include a second transmission mode, which may be based on a second messaging service of a second application. The second application is different from the first application. For example, a user A corresponding to interaction item 215-1 may be associated with the second application, as shown in FIG. 2B. The electronic device 110 may receive the selection of the interaction item 215-1 by the current user, and send the interaction message to the user A in the second application based on the second messaging service of the second application.

In some embodiments, the plurality of predetermined transmission modes may include a third transmission mode, which may be based on a Short Messaging Service (SMS). As an example, the user B corresponding to the interaction item 215-2 may be associated with a fourth application that transmits messages based on a Short Messaging Service. The electronic device 110 may receive the selection of the interaction item 215-2 by the current user, and send the interaction message to the user B based on the Short Messaging Service.

In some embodiments, the electronic device 110 may provide the first access entry associated with the first application in the interaction message, in response to the target transmission mode being the second transmission mode or the third transmission mode.

In some embodiments, the first access entry may be configured to direct to a viewing interface of the first application to show the selected target interaction item. As an example, a client of a user A or a user B may present a viewing interface of the first application in response to a trigger (for example, a clicking operation) to a first access entry in a received interaction message. The viewing interface of the first application may show a target interaction item selected by the current user and description content associated with the target interaction item.

In some embodiments, the first access entry may be configured to direct to a download interface for downloading the first application. As an example, a client of user A or user B may present a download interface for a first application in response to a trigger (e.g., a clicking operation) to a first access entry in a received interaction message. As such, the user A or the user B may download the first application in their client based on the first access entry in the interaction message.

In some embodiments, with continued reference to FIG. 2B, the electronic device 110 may provide an update control 220 in the interaction component 210. Further, the electronic device 110 may update the description content and/or the plurality of interaction items 215 in the interaction component 210 in response to receiving the trigger to the update control 220.

In some embodiments, as shown in FIG. 2C, the electronic device 110 may present, in the viewing interface 200C, an interaction component 210 updated via triggering of the update control 220. As an example, a plurality of interaction items 215 of the updated interaction component 210 may correspond to one candidate user (e.g., user E). The description content of the updated interaction component 210 may be, for example, “you think user E is most likely to be”, and the plurality of interaction items 215 may correspond to a plurality of option contents (e.g., option 1, option 2, option 3, and option 4). Further, in response to receiving a selection of a target interaction item (e.g., an interaction item associated with option 2) among the plurality of interaction items, the electronic device 110 may send an interaction message corresponding to the target interaction item to the user E.

In some embodiments, as shown in FIG. 2D, the electronic device 110 may present the interaction component in a third application different from the first application. Further, the electronic device 110 may present, in the third application, a second access entry 225 associated with the first application, in response to receiving the selection of the target interaction item. As an example, the electronic device 110 may present a viewing interface or download interface of the first application in response to a trigger (e.g., a clicking operation) to the second access entry 225. As an example, the viewing interface of the first application may show the target interaction item selected by the current user and description content associated with the target interaction item.

Based on the procedures described above, the embodiments of the present disclosure can provide a user with a plurality of interaction items associated with a plurality of transmission modes. Further, in the embodiments of the present disclosure, the interaction message may be sent to the user corresponding to the target interaction item based on the transmission mode corresponding to the target interaction item selected by the current user. In this way, embodiments of the present disclosure can provide the current user with a plurality of transmission modes for interaction, which can meet a need of the current user to interact with users from different sources, and can improve interaction efficiency.

### Push and Interaction of Interaction Messages

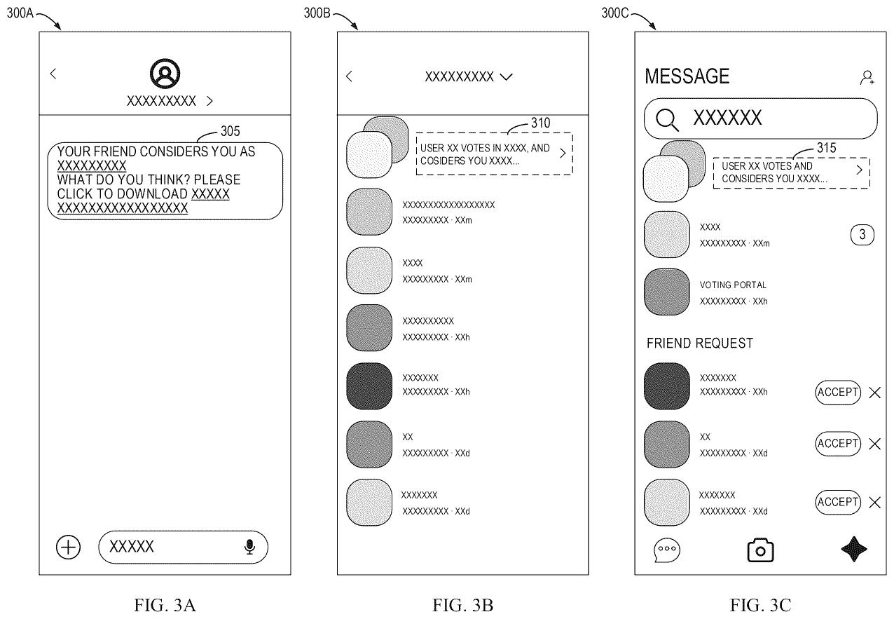

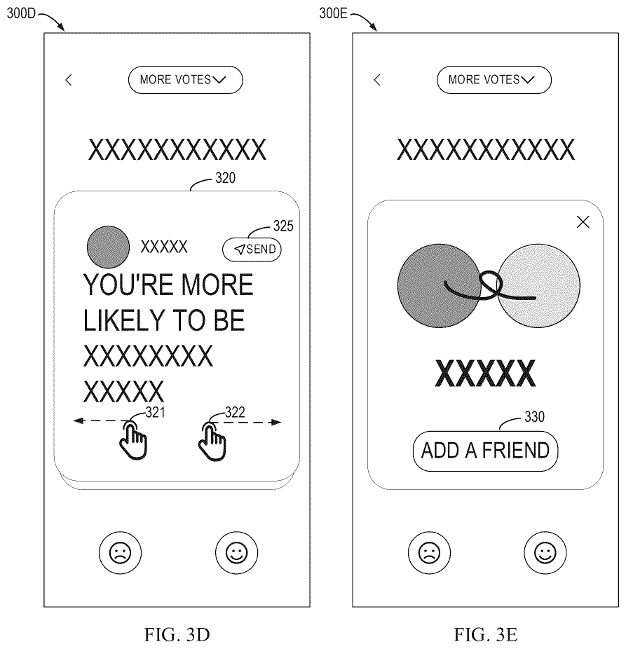

FIGS. 3A-3E illustrate example interfaces 300A-300E according to some embodiments of the disclosure. The interfaces 300A-300E may be provided, for example, by the electronic device 110 shown in FIG. 1.

In some embodiments, as shown in FIG. 3A, the electronic device 110 may present a first interaction message 305 received from a first application according to a third transmission mode based on a Short Messaging service SMS. As an example, the first interaction message 305 may include content information (e.g., information of a message sender, a sending time, a description content, etc.). As an example, the first interaction message 305 may also include a first access entry (e.g., an access address or download address, etc.) associated with the first application.

By way of example, the electronic device 110 may present a portion of the content of the first interaction message 305 (e.g., your friend considers you as “ ”). Further, the electronic device 110 may, in response to receiving the trigger to the first access entry, present a viewing interface or download interface of the first application. As an example, the electronic device 110 may present full content of the first interaction message (e.g., your friend considers you as a “game master”) in the viewing interface of the first application. As an example, the electronic device 110 may trigger to download the first application, in response to receiving a download request from a user at a download interface of the first application (e.g., receiving a clicking operation on a download control).

In some embodiments, as shown in FIG. 3B, the electronic device 110 may present a second interaction message 310 received from the first application based on the second transmission mode. As an example, the second interaction message 310 may include content information (e.g., information of a message sender, a sending time, a description content, etc.). As an example, the second interaction message 310 may provide a second access entry (e.g., an access address or a download address, etc.) associated with the first application. By way of example, the electronic device 110 may present a portion of content of the second interaction message 310 (e.g., your friend gives you a score of “ ”). Further, as an example, the electronic device 110 may present the viewing interface or download interface of the first application in response to receiving a trigger (e.g., a clicking operation) for the second interaction message 310. By way of example, the electronic device 110 may present full content of the first interaction message in the viewing interface of the first application (e.g., your friend gives you a score of “100”). As an example, the electronic device 110 may trigger to download the first application in response to receiving a download request from a user in a download interface of the first application (e.g., receiving a clicking operation on a download control).

In some embodiments, as shown in FIG. 3C, the electronic device 110 may present a third interaction message 315 received from another user of the first application based on the first transmission mode. As an example, the third interaction message 315 may include content information (e.g., information of the message sender, a sending time, a description content, etc.). As an example, the electronic device 110 may present, in response to receiving a trigger (e.g., a clicking operation) to the third interaction message 315, a conversation interface with a user (e.g., a message sender) associated with the third interaction message 315, and may present the third interaction message 315 in the conversation interface.

In some embodiments, as shown in FIG. 3D, the electronic device 110 may present, in the viewing interface 300D of the first application, a first fourth interaction message 320 in a plurality of fourth interaction messages 320 received by the user from other plurality of users in the first application.

In some embodiments, with continued reference to FIG. 3D, the electronic device 110 may send the message to the user associated with the fourth interaction message 320 (e.g., the sender of the fourth interaction message) in response to receiving the user's predetermined operation in the viewing interface.

By way of example, the electronic device 110 may provide a sending control 325 in the viewing interface 300D. Further, the electronic device 110 may send the message to the user associated with the fourth interaction message in response to receiving the trigger to the sending control 325. As an example, the message may be a predetermined reply message, or may be text content obtained based on the sending control 325 and input by the user based on a natural language.

As an example, the electronic device 110 may send, in response to receiving a target operation of the user in the viewing interface 300D, a message corresponding to the target operation to the user associated with the fourth interaction message.

As an example, the electronic device 110 may receive an operation 321 (also referred to as a target operation) of the user. In some embodiments, such operation 321 may indicate a target direction. For example, the operation 321 may include a swipe operation toward the target direction, e.g., a left swipe operation. As an example, the electronic device 110 may send a message (e.g., a sad) corresponding to operation 321 to the user associated with the fourth interaction message.

As an example, the electronic device 110 may receive an operation 322 (also referred to as a target operation) of the user. In some embodiments, such operation 322 may be of an opposite type of operation 321 described above (e.g., a right swipe operation), and the operation 322 and operation 321 may correspond to different interaction areas in the interface. As an example, the electronic device 110 may send a message (e.g., happiness) corresponding to operation 322 to the user associated with the fourth interaction message.

In some embodiments, with continued reference to FIG. 3D, the electronic device 110 may also present a second fourth interaction message 320 of the plurality of fourth interaction messages 320 in response to receiving a target operation of the user (such as the operation 321 or operation 322 described above).

In some embodiments, as shown in FIG. 3E, the electronic device 110 may also present an adding control 330 in the viewing interface 300E, in response to receiving a target operation of the user (the operation 321 or operation 322 as described above). Further, the electronic device 110 may send a friend adding request from the current user to the user associated with the fourth interaction message 320, in response to a trigger (e.g., a clicking operation) to the adding control 330. In this way, a user receiving an interaction message may conveniently add a message sender as a friend, thereby improving interaction efficiency.

Based on the procedures described above, the embodiments of the present disclosure can present an interaction message from a first application in different applications, and provide a way for a user to view the interaction message or download the first application. In addition, the embodiments of the present disclosure can provide a reply message and a shortcut for adding friends for the user who receives the interaction message in the first application. Therefore, the embodiments of the present disclosure can satisfy the needs of users between different applications performing message interaction, and can help a user to quickly reply to a message, establish a friend relationship and download an application, thereby improving the interaction efficiency between users.

### Example Processes

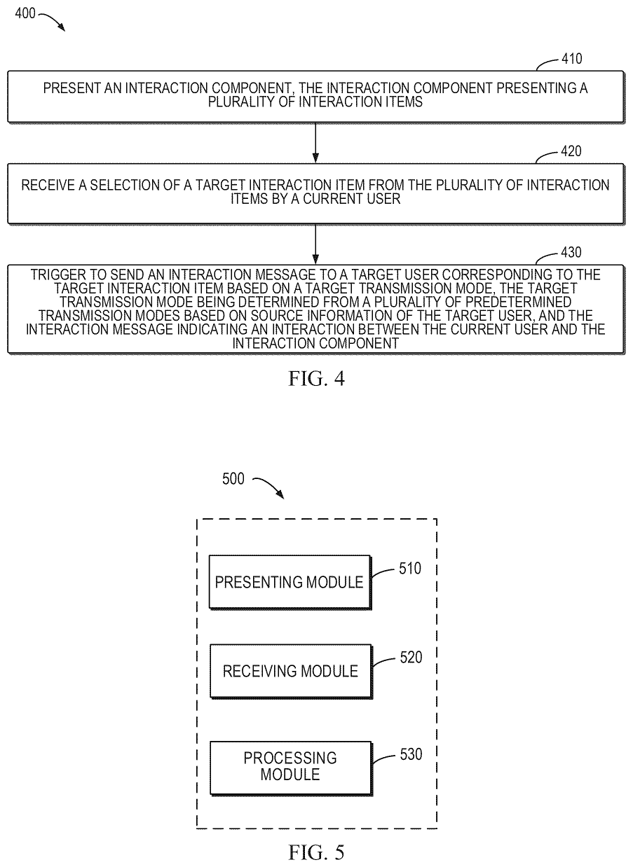

FIG. 4 illustrates a flowchart of an example process 400 for generating media content according to some embodiments of the disclosure. The process 400 may be implemented at electronic device 110. The process 400 is described below with reference to FIG. 1.

As shown, at block 410, the electronic device 110 presents an interaction component that presents multiple interaction items.

At block 420, the electronic device 110 receives a selection of a target interaction item from the plurality of interaction items by a current user.

At block 430, the electronic device 110 triggers to send an interaction message to a target user corresponding to the target interaction item based on a target transmission mode, wherein the target transmission mode is determined from a plurality of predetermined transmission modes based on source information of the target user, and the interaction message indicates an interaction between the current user and the interaction component.

In some embodiments, the interaction component is associated with a first application. The plurality of predetermined transmission modes comprises: a first transmission mode, the first transmission mode being based on a first messaging service of the first application; a second transmission mode, the second transmission mode being based on a second messaging service of a second application, the second application being different from the first application; a third transmission mode, the third transmission mode being based on a Short Messaging service SMS.

In some embodiments, the source information of the target user indicates that the target user is associated with a first application; the target user is associated with a second application; or the target user is determined based on communication information associated with the current user.

In some embodiments, in response to the target transmission mode being the second transmission mode or the third transmission mode, the interaction message comprises a first access entry associated with the first application.

In some embodiments, the first access entry is configured to direct to a viewing interface of the first application to show the selected target interaction item; or direct to a download interface for downloading the first application.

In some embodiments, presenting the interaction component includes presenting the interaction component in a third application different from the first application. The process 400 further includes in response to the selection of the target interaction item, presenting, in the third application, a second access entry associated with the first application.

In some embodiments, the interaction component further presents description content, the plurality of interaction items corresponds to a plurality of candidate users, and the selection of the target interaction item indicates that the target user matches the description content.

In some embodiments, the plurality of candidate users is determined from a set of candidate users associated with the current user.

In some embodiments, the process 400 further includes presenting, in the interaction component, an indication element corresponding to at least one interaction item of the plurality of interaction items. The indication element represents a source type of at least one candidate user corresponding to the at least one interaction item.

In some embodiments, the plurality of interaction items includes identification information of the plurality of candidate users, and the identification information comprises an image identification and/or a text identification.

In some embodiments, presenting the interaction component includes presenting the interaction component in a viewing interface of the information stream.

### Example Apparatus and Devices

Embodiments of the present disclosure also provide a corresponding apparatus for performing the methods or processes described above. FIG. 5 illustrates a schematic structural block diagram of an example apparatus 500 for generating media content according to certain embodiments of the present disclosure. The apparatus 500 may be implemented as or included in an electronic device. The various modules/components in the apparatus 500 may be implemented by hardware, software, firmware, or any combination thereof.

As shown in FIG. 5, the apparatus 500 includes a presenting module 510 configured to present an interaction component, wherein the interaction component presents a plurality of interaction items; a receiving module 520 configured to receive a selection of a target interaction item from the plurality of interaction items by a current user; and a processing module 530 configured to trigger to send an interaction message to a target user corresponding to the target interaction item based on a target transmission mode, wherein the target transmission mode is determined from a plurality of predetermined transmission modes based on source information of the target user, and the interaction message indicates an interaction between the current user and the interaction component.

In some embodiments, the interaction component is associated with a first application. The plurality of predetermined transmission modes comprises: a first transmission mode, the first transmission mode being based on a first messaging service of the first application; a second transmission mode, the second transmission mode being based on a second messaging service of a second application, the second application being different from the first application; a third transmission mode, the third transmission mode being based on a Short Messaging service SMS.

In some embodiments, the source information of the target user indicates that: the target user is associated with a first application; the target user is associated with a second application; or the target user is determined based on communication information associated with the current user.

In some embodiments, in response to the target transmission mode being the second transmission mode or the third transmission mode, the interaction message includes a first access entry associated with the first application.

In some embodiments, the first access entry is configured to: direct to a viewing interface of the first application to show the selected target interaction item; or direct to a download interface for downloading the first application.

In some embodiments, the presenting module 510 is further configured to present the interaction component in a third application different from the first application. Further, the apparatus 500 comprises: in response to the selection of the target interaction item, present, in the third application, a second access entry associated with the first application.

In some embodiments, the interaction component further presents the description content. The plurality of interaction items corresponds to a plurality of candidate users. In addition, the selection of the target interaction item indicates that the target user matches the description content.

In some embodiments, the plurality of candidate users is determined from a set of candidate users associated with the current user.

In some embodiments, the apparatus 500 further includes an indicating module configured to present, in the interaction component, an indication element corresponding to at least one interaction item of the plurality of interaction items. The indication element represents a source type of at least one candidate user corresponding to the at least one interaction item.

In some embodiments, the plurality of interaction items includes identification information of the plurality of candidate users. The identification information comprises an image identification and/or a text identification.

In some embodiments, the presenting module 510 is further configured to present the interaction component in a viewing interface of an information stream.

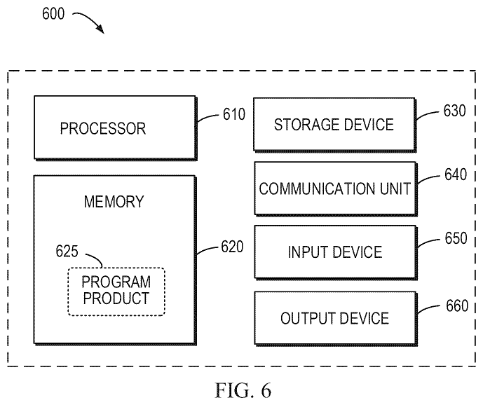

FIG. 6 illustrates a block diagram of an electronic device 600 in which one or more embodiments of the present disclosure may be implemented. It should be appreciated that the electronic device 600 shown in FIG. 6 is merely illustrative and should not constitute any limitation on the functionality and scope of the embodiments described herein. The electronic device 600 shown in FIG. 6 may be used in an electronic device.

As shown in FIG. 6, the electronic device 600 is in the form of a general-purpose electronic device. Components of the electronic device 600 may include, but are not limited to, one or more processors or processors 610, a memory 620, a storage device 630, one or more communications units 640, one or more input devices 650, and one or more output devices 660. The processor 610 may be an actual or virtual processor and can perform various processes according to programs stored in the memory 620. In a multiprocessor system, a plurality of processors executes computer executable instructions in parallel, so as to improve the parallel processing capability of the electronic device 600.

The electronic device 600 typically includes a number of computer storage media. Such media may be any available media that are accessible by electronic device 600, including, but not limited to, volatile and non-volatile media, removable and non-removable media. The memory 620 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium such as a flash drive, a magnetic disk, or any other medium that can be used to store information and/or data and that can be accessed within the electronic device 600.

The electronic device 600 may further include additional removable/non-removable, volatile/nonvolatile storage media. Although not shown in FIG. 6, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines can communicate through a communication connection. Thus, the electronic device 600 may operate in a networked environment using logical connections to one or more other servers, network personal computers (PCs), or another network node.

The input device 650 may be one or more input devices such as a mouse, keyboard, trackball, etc. The output device 660 may be one or more output devices such as a display, speaker, printer, etc. The electronic device 600 may also communicate with one or more external devices (not shown) such as a storage device, a display device, or the like through the communication unit 640 as required, and communicate with one or more devices that enable a user to interact with the electronic device 600, or communicate with any device (e.g., a network card, a modem, or the like) that enables the electronic device 600 to communicate with one or more other electronic devices. Such communication may be performed via an input/output (I/O) interface (not shown).

According to an illustrative implementation of the present disclosure, a computer readable storage medium is provided, on which a computer-executable instruction is stored, wherein the computer executable instruction is executed by a processor to implement the above-described method. According to an illustrative implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices, and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for message interaction, comprising:
presenting an interaction component, the interaction component presenting a plurality of interaction items;
receiving a selection of a target interaction item from the plurality of interaction items by a current user; and
triggering to send an interaction message to a target user corresponding to the target interaction item based on a target transmission mode, the target transmission mode being determined from a plurality of predetermined transmission modes based on source information of the target user, and the interaction message indicating an interaction between the current user and the interaction component.

2. The method of claim 1, wherein the interaction component is associated with a first application, and the plurality of predetermined transmission modes comprises:
a first transmission mode, the first transmission mode being based on a first messaging service of the first application;
a second transmission mode, the second transmission mode being based on a second messaging service of a second application, the second application being different from the first application;
a third transmission mode, the third transmission mode being based on a Short Messaging service SMS.

3. The method of claim 2, wherein the source information of the target user indicates:
the target user is associated with the first application;
the target user is associated with the second application; or
the target user is determined based on communication information associated with the current user.

4. The method of claim 2, wherein:
in response to the target transmission mode being the second transmission mode or the third transmission mode, the interaction message comprises a first access entry associated with the first application.

5. The method of claim 4, wherein the first access entry is configured to:
direct to a viewing interface of the first application to show the selected target interaction item; or
direct to a download interface for downloading the first application.

6. The method of claim 2, wherein presenting the interaction component comprises presenting the interaction component in a third application different from the first application, and the method further comprises:
in response to the selection of the target interaction item, presenting, in the third application, a second access entry associated with the first application.

7. The method of claim 1, wherein the interaction component further presents description content, the plurality of interaction items corresponds to a plurality of candidate users, and the selection of the target interaction item indicates that the target user matches the description content.

8. The method of claim 7, wherein the plurality of candidate users is determined from a set of candidate users associated with the current user.

9. The method of claim 7, further comprising:
presenting, in the interaction component, an indication element corresponding to at least one interaction item of the plurality of interaction items, the indication element representing a source type of at least one candidate user corresponding to the at least one interaction item.

10. The method of claim 7, wherein the plurality of interaction items comprises identification information of the plurality of candidate users, and the identification information comprises an image identification and/or a text identification.

11. The method of claim 1, wherein presenting the interaction component comprises:
presenting the interaction component in a viewing interface of an information stream.

12. An electronic device, comprising:
at least one processor; and
at least one memory coupled to the at least one processor and storing instructions for execution by the at least one processor that, when executed by the at least one processor, cause the electronic device to perform acts comprising:
presenting an interaction component, the interaction component presenting a plurality of interaction items;
receiving a selection of a target interaction item from the plurality of interaction items by a current user; and
triggering to send an interaction message to a target user corresponding to the target interaction item based on a target transmission mode, the target transmission mode being determined from a plurality of predetermined transmission modes based on source information of the target user, and the interaction message indicating an interaction between the current user and the interaction component.

13. The electronic device of claim 12, wherein the interaction component is associated with a first application, and the plurality of predetermined transmission modes comprises:
a first transmission mode, the first transmission mode being based on a first messaging service of the first application;
a second transmission mode, the second transmission mode being based on a second messaging service of a second application, the second application being different from the first application;
a third transmission mode, the third transmission mode being based on a Short Messaging service SMS.

14. The electronic device of claim 13, wherein the source information of the target user indicates:
the target user is associated with the first application;
the target user is associated with the second application; or
the target user is determined based on communication information associated with the current user.

15. The electronic device of claim 13, wherein:
in response to the target transmission mode being the second transmission mode or the third transmission mode, the interaction message comprises a first access entry associated with the first application.

16. The electronic device of claim 15, wherein the first access entry is configured to:
direct to a viewing interface of the first application to show the selected target interaction item; or
direct to a download interface for downloading the first application.

17. The electronic device of claim 13, wherein presenting the interaction component comprises presenting the interaction component in a third application different from the first application, and the acts further comprise:
in response to the selection of the target interaction item, presenting, in the third application, a second access entry associated with the first application.

18. The electronic device of claim 12, wherein the interaction component further presents description content, the plurality of interaction items corresponds to a plurality of candidate users, and the selection of the target interaction item indicates that the target user matches the description content.

19. The electronic device of claim 18, wherein the plurality of candidate users is determined from a set of candidate users associated with the current user.

20. A non-transitory computer readable storage medium having a computer program stored thereon, wherein the computer program is executable by a processor to implement a method comprising:
presenting an interaction component, the interaction component presenting a plurality of interaction items;
receiving a selection of a target interaction item from the plurality of interaction items by a current user; and
triggering to send an interaction message to a target user corresponding to the target interaction item based on a target transmission mode, the target transmission mode being determined from a plurality of predetermined transmission modes based on source information of the target user, and the interaction message indicating an interaction between the current user and the interaction component.
